(19) United States
(12) Patent Application Publication
(10) Pub. No.: US 2006/0061228 A1
(43) Pub. Date: Mar. 23, 2006

(54) Flux concentrated-type motor

(75) Inventors: Sung Ho Lee, Anyang-si (KR); Jin Soo Park, Inchun-si (KR); Young Kwan Kim, Buchun-si (KR); Deok Jin Kim, Hwasung-si (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/202,160

(22) Filed: Aug. 12, 2005

(30) Foreign Application Priority Data
Sep. 17, 2004 (KR) 2004-74522

(51) Int. Cl. H02K 7/00; H02K 1/27

(52) U.S. Cl. 310/156.57; 310/67 R; 310/217

(57) ABSTRACT

A flux concentration-type motor includes a ring-shaped stator, in which coils are wound on a plurality of teeth radially arranged; and a rotor, located at the center of the stator, having a plurality of magnets arranged in a circumferential direction such that poles, having the same polarity, of the magnets face each other, and rotated by the interaction with the stator, so as to prevent the leakage of magnetic flux of the magnets, thereby improving the torque compared to a conventional surface mounted permanent magnet-type motor having the same volume, reducing the production costs, and facilitating the miniaturization of products.

### BACKGROUND OF THE INVENTION

1. Field of the Invention

The present invention relates to a motor for driving a washing machine, and more particularly to a flux concentration-type motor having an internal rotatable structure.

2. Description of the Related Art

Generally, permanent magnet-type motors are divided into a surface mounted permanent magnet-type motor and an interior permanent magnet-type motor according to the configurations of magnetic circuits.

A motor for directly driving employs a washing machine an outer rotor-fashioned, surface mounted, and permanent magnet-type motor.

FIGS. 1 and 2 illustrate a motor for driving a washing machine. FIGS. 1 and 2 are respectively exploded perspective and plan views of an external rotatable motor, which is one type of the conventional surface mounted, permanent magnet-type motors.

The above surface mounted permanent magnet-type motor, in which a rotor 20 is installed outside a stator 10, mainly comprises the stator 10, and the rotor 20, which is rotatably installed outside the stator 10 such that the inner surface of the rotor 20 is spaced apart from the outer surface of the stator 10 in a radial direction by a designated air gap.

The stator 10 includes a ring-shaped core 12, a plurality of teeth 15 formed on the outer circumferential surface of the ring-shaped core 12 such that the teeth 13 are separated from each other by designated slots 14 in the circumferential direction of the core 12, and coils 17 concentratedly wound on the corresponding teeth 15 and connected to an external power source.

The rotor 20 includes a ring-shaped rotor frame 22 constituting a back yoke serving as a channel for magnetic flux, and a magnet 25, consisting of a plurality of pieces such that N and S poles are alternately arranged on the inner circumferential surface of the rotor frame 22 in a radial direction, rotated by the electromagnetic interaction of the pieces when a current flows along the coils 17.

In the above surface mounted permanent magnet-type motor, the stator 10 is attached to an outer tub of a washing machine by connection holes 13 formed through the core 12, and the central portion of the rotor frame 22 of the rotor 20 is connected to an inner tub or a pulsator of the washing machine by shafts.

The surface mounted permanent magnet-type motor does not have a difference of reluctance due to the relative position of magnetic poles formed by the magnetic flux of the stator 10 and the magnetic flux of the rotor 20, thereby allowing the rotor 20 to have a non-salient pole structure. FIG. 3 is a detailed view illustrating a magnetic flux distribution according to the relative position of the rotor 20 in the conventional surface mounted permanent magnet-type motor.

In order to increase the back electromotive force of the conventional surface mounted permanent magnet-type motor, the rotor 20 has a longer length than the stacked length of the stator 10. The elongated portion of the rotor is referred to as an “overhang”. The overhang serves to increase the magnetic flux of the magnet 25, interlinked with the coils 17 of the stator 10, to a designated amount, thereby increasing the back electromotive force.

The back electromotive force of the above surface mounted permanent magnet-type motor is increased in proportion to the increase of the length of the overhang of the rotor 20, but is not increased and is constantly maintained when the length of the overhang of the rotor 20 reaches a designated value. This is caused by the structure of the surface mounted permanent magnet-type motor, i.e., since the increase of the length of the overhang increases the amount of the magnetic flux, which is not interlinked with the coils and leaked through other portions.

FIG. 4 is a graph illustrating the variation of the magnetic flux density at teeth of the stator according to the variation of the length of an overhang of the rotor in the conventional surface mounted permanent magnet-type motor. The magnetic flux density of the teeth is increased in proportion to the increase of the length of the overhang of the rotor, but is not increased and is saturated when the length of the overhang is more than approximately 6 mm. This is caused by the increase in the amount of a part of the magnetic flux, which is leaked through other portions except for the effective magnetic flux passing through the teeth, according to the increase of the length of the overhang.

Accordingly, the above-described conventional surface mounted permanent magnet-type motor has the overhang for increasing the magnetic flux, interlinked with the coils of the stator 10, to a designated mount, so as to increase the back electromotive force. However, since the effects of the overhang are lost when the length of the overhang is increased to a designated value or more, the conventional surface mounted permanent magnet-type motor is disadvantageous in that the increase of the back electromotive force is limited.

### SUMMARY OF THE INVENTION

Therefore, the present invention has been made in view of the above problems, and it is an object of the present invention to provide a flux concentration-type motor, in which a plurality of magnets are arranged in the circumferential direction such that the same poles of the magnets face each other, thereby reducing the leakage of magnetic flux of the magnets and improving the torque compared to a conventional surface mounted permanent magnet-type motor having the same volume.

In accordance with one aspect of the present invention, the above and other objects can be accomplished by the provision of a flux concentration-type motor comprising: a ring-shaped stator, in which coils are wound on a plurality of teeth radially arranged; and a rotor, located at the center of the stator, having a plurality of magnets arranged in a circumferential direction such that poles, having the same polarity, of the magnets face each other, and rotated by the interaction with the stator.

Preferably, the stator may include a ring-shaped core; a plurality of the teeth protruded from the inner circumferential surface of the core and radially arranged; and the coils wound on the corresponding teeth and connected to an external power source.

More preferably, indents for connecting the stator may be formed in the outer circumferential surface of the core of the stator.

Preferably, the rotor may include a ring-shaped rotor core; a plurality of teeth protruded from the core toward the stator and radially arranged; and a plurality of the magnets arranged between the teeth.

Further, preferably, a flux barrier for preventing the leakage of magnetic flux of the magnets may be formed in the core or in connection portions between the core and the teeth.

More preferably, the flux barrier may include at least one of pin holes formed through the connection portions between the core and the teeth, barrier holes formed through ends of the teeth adjacent to the core, and bridge holes formed through portions for connecting the neighboring teeth.

Preferably, the core of the rotor may be produced by spiral winding.

Further, preferably, guide holes for stacking plural sheets using iron rods may be formed through the core of the rotor.

The flux concentration-type motor of the present invention, which comprises the flux concentration-type rotor including a plurality of the magnets arranged in the circumferential direction such that the same poles of the magnets face each other, so as to prevent the leakage of magnetic flux of the magnets, thereby improving the torque compared to a conventional surface mounted permanent magnet-type motor having the same volume, reducing the production costs, and facilitating the miniaturization of products.

Further, since the flux barrier is installed in the rotor core of the motor for maximally preventing the leakage of magnetic flux of the magnets, the flux concentration-type motor of the present invention improves the overall performance thereof due to the improvement of the torque thereof.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an exploded perspective view of a conventional surface mounted permanent magnet-type motor;

FIG. 2 is a plan view of the conventional surface mounted permanent magnet-type motor;

FIG. 3 is a detailed view illustrating a magnetic flux distribution according to the relative position of a rotor in the conventional surface mounted permanent magnet-type motor;

FIG. 4 is a graph illustrating the variation of a magnetic flux density according to the variation of the length of an overhang in the conventional surface mounted permanent magnet-type motor;

FIG. 5 is a plan view of a flux concentration-type motor in accordance with the present invention;

FIGS. 6A, 6B, and 6C are enlarged views respectively illustrating several embodiments of a flux barrier of the flux concentration-type motor of the present invention;

FIGS. 7A is 7B are schematic views illustrating magnetization directions of the flux concentration-type motor of the present invention and the conventional surface mounted permanent magnet-type motor;

FIG. 8 is a graph illustrating the variation of characteristics according to the thickness of bridges of a rotor in the flux concentration-type motor of the present invention; and

FIG. 9 is a graph illustrating the variation of torque according to the variation of the rotational frequencies of the flux concentration-type motor of the present invention and the conventional surface mounted permanent magnet-type motor.

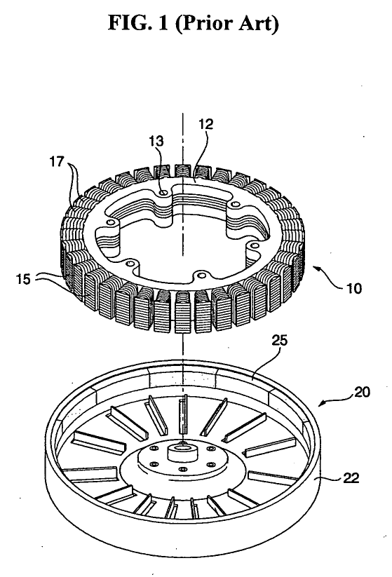

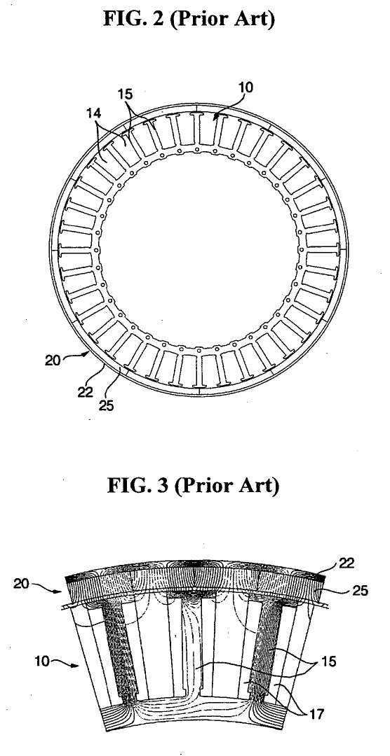

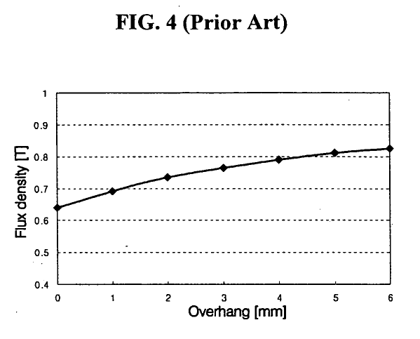

### DESCRIPTION OF THE PREFERRED EMBODIMENTS

Now, a preferred embodiment of a permanent magnet-type motor in accordance with the present invention will be described in detail with reference to the annexed drawings.

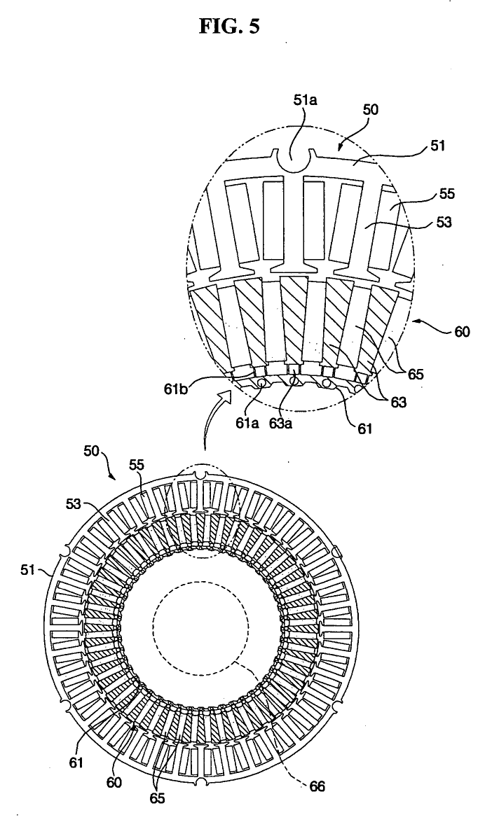

FIG. 5 is a plan view of a flux concentration-type motor in accordance with the present invention.

The flux concentration-type motor of the present invention comprises a ring-shaped stator 50 having a plurality of teeth 53 formed in a radial direction and coils 55 wound on the teeth 53, and a rotor 60 located at the center of the stator 50, including a plurality of magnets arranged in a circumferential direction such that the poles, having the same polarity, of the magnets face each other, and rotated by the interaction with the coils 55 of the stator 50.

The stator 50 includes a ring-shaped core 51 forming an external appearance, a plurality of the teeth 53 protruded from the inner circumferential surface of the core 51 toward the rotor 60 and arranged in the radial direction, and the coils 55 wound on the corresponding teeth 53 and connected to an external power source.

Indents 51a for connecting the stator 50 are formed in the outer circumferential surface of the core 51.

The rotor 60 includes a ring-shaped rotor core 61, a plurality of teeth 63 protruded from the core 61 toward the stator 50 in the radial direction, and a plurality of magnets 65 arranged between the teeth 63.

The core 61 is fixedly connected to a rotor frame 66, to which a rotary shaft at the center of the rotor 60 is fixed.

Here, in order to prevent magnetic flux from being leaked in the direction toward the center of the rotor 60 rather than in the direction toward the stator 50 to prevent the rapid deterioration of the torque due to the leakage of magnetic flux, a flux barrier is formed in the core 61 or connection portions between the core 61 and the teeth 63.

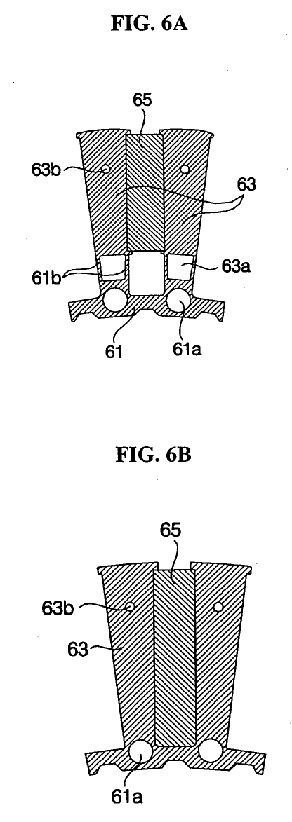

FIGS. 6A, 6B, and 6C are enlarged views respectively illustrating several embodiments of the flux barrier of the flux concentration-type motor of the present invention. One embodiment of the flux barrier of FIG. 6A includes pin holes 61a having a circular cross-section formed through the connection portions between the core 61 and the teeth 63, barrier holes 63a having a rectangular cross-section formed through ends of the teeth 63 adjacent to the core 61, and bridges 61b formed at both sides of each of the barrier holes 63a for connecting the core 61 and the teeth 63.

Another embodiment of the flux barrier of FIG. 6B includes the pin holes 61a having a circular cross-section formed through the connection portions between the core 61 and the teeth 63.

Yet another embodiment of the flux barrier of FIG. 6C includes the pin holes 61a having a circular cross-section formed through the connection portions between the core 61 and the teeth 63, and bridge holes 61c having a small rectangular. cross-section formed through bridges 61b for connecting the neighboring teeth 63.

In FIGS. 6A, 6B, and 6C, guide pins are inserted into the pin holes 61a, when the core 61 is produced by spiral winding, and reference numeral 63b denote holes for vertically arranging the teeth 63 at accurate positions when the rotor 60 is obtained by stacking sheets using iron rods.

Hereinafter, the function of the flux concentration-type motor of the present invention will be described in detail.

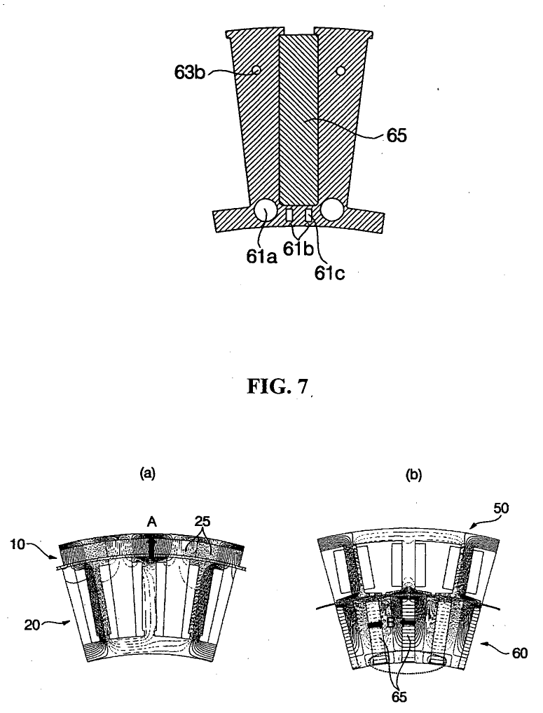

In the conventional surface mounted permanent magnet-type motor as shown in FIG. 7A, the magnets 25 are arranged in the radial direction (A). On the other hand, in the flux concentration-type motor as shown in FIG. 7B, the magnets 65 are arranged in the circumferential direction (B) such that the same poles of the magnets 65 face each other.

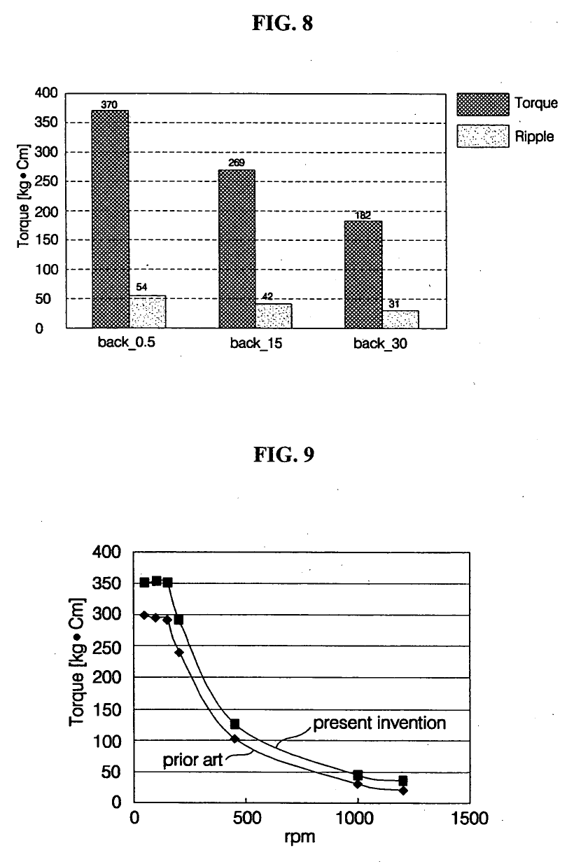

FIG. 8 is a graph illustrating the variation of torque and ripple characteristics according to the thickness of the core bridges 61b for connecting the lower portions of the magnets 65. As shown in FIG. 8, when the thickness of the bridges 61b was increased from the 0.5 mm to 3.0 mm, the torque was reduced approximately 50%. Accordingly, in order to minimize the leakage of the magnetic flux of the magnets 65, as shown in FIGS. 6A, 6B, and 6C, the pin holes 61a, the bridge holes 61c, and/or the barrier holes 63a are properly formed in the motor, thereby facilitating the optimum design of the flux barrier.

FIG. 9 is a graph illustrating the variation of the torque according to the variation of the rotational frequencies of the flux concentration-type motor of the present invention and the conventional surface mounted permanent magnet-type motor. FIG. 9 illustrates that the flux concentration-type motor of the present invention has an improved torque compared to the conventional surface mounted permanent magnet-type motor having the same stack structure and volume. That is, since the torque of the conventional surface mounted permanent magnet-type motor at an initial rotating state was 314 kg·cm, and the torque of the flux concentration-type motor of the present invention was 346 kg·cm, it is proved that the torque of the flux concentration-type motor of the present invention is improved.

Accordingly, the flux concentration-type motor of the present invention, which is applied to a load having the same torque, reduces the stacked thickness of the motor and the amount of the winding coils, thereby reducing the overall production costs of the motor. Further, since it is possible to miniaturize the motor due to the reduction of the staked thickness at the same torque, the flux concentration-type motor of the present invention increases the degree of freedom in designing a drum washing machine employing the motor, and facilitates the increase of the capacity of the drum washing machine.

As apparent from the above description, the present invention provides a flux concentration-type motor, which comprises a flux concentration-type rotor including a plurality of magnets arranged in the circumferential direction such that the same poles of the magnets face each other, so as to prevent the leakage of magnetic flux of the magnets, thereby improving the torque compared to a conventional surface mounted permanent magnet-type motor having the same volume, reducing the production costs, and facilitating the miniaturization of products.

Further, since a flux barrier is installed in a rotor core of the motor for maximally preventing the leakage of magnetic flux of the magnets, the flux concentration-type motor of the present invention improves overall performance thereof due to the improvement of the torque thereof.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

The present disclosure relates to subject matter contained in Korean Application No. 10-2004-0074522, filed on Sep. 17, 2004, the contents of which are herein expressly incorporated by reference in its entirety.

What is claimed is:

1. A flux concentration-type motor comprising:
a ring-shaped stator, in which coils are wound on a plurality of teeth radially arranged; and
a rotor, located at the center of the stator, having a plurality of magnets arranged in a circumferential direction such that poles, having the same polarity, of the magnets face each other, and rotated by the interaction with the stator.

2. The flux concentration-type motor as set forth in claim 1, wherein the stator includes:
a ring-shaped core;
a plurality of the teeth protruded from the inner circumferential surface of the core and radially arranged; and
the coils wound on the corresponding teeth and connected to an external power source.

3. The flux concentration-type motor as set forth in claim 2,
wherein indents for connecting the stator are formed in the outer circumferential surface of the core of the stator.

4. The flux concentration-type motor as set forth in claim 1, wherein the rotor includes:
a ring-shaped rotor core;
a plurality of teeth protruded from the core toward the stator and radially arranged; and
a plurality of the magnets arranged between the teeth.

5. The flux concentration-type motor as set forth in claim 4,
wherein a flux barrier for preventing the leakage of magnetic flux of the magnets is formed in the core or in connection portions between the core and the teeth.

6. The flux concentration-type motor as set forth in claim 5,
wherein the flux barrier includes pin holes formed through the connection portions between the core and the teeth.

7. The flux concentration-type motor as set forth in claim 5,
wherein the flux barrier includes barrier holes formed through ends of the teeth adjacent to the core.

8. The flux concentration-type motor as set forth in claim 5,
wherein the flux barrier includes bridge holes formed through portions for connecting the neighboring teeth.

9. The flux concentration-type motor as set forth in claim 4,
wherein the core of the rotor is produced by spiral winding.

10. The flux concentration-type motor as set forth in claim 9,
wherein guide holes for stacking plural sheets using iron rods are formed through the core of the rotor.

11. A flux concentration-type motor comprising:
a stator including a ring-shaped core, a plurality of teeth protruded from the inner circumferential surface of the core and radially arranged, and coils wound on the corresponding teeth and connected to an external power source; and
a rotor including a ring-shaped rotor core placed at the center of the stator, a plurality of teeth protruded from the core toward the stator and radially arranged, and a plurality of magnets arranged between the teeth such that the poles, having the same polarity, of the magnets face each other, and rotated by the interaction with the stator.

12. The flux concentration-type motor as set forth in claim 11,
wherein indents for connecting the stator are formed in the outer circumferential surface of the core of the stator.

13. The flux concentration-type motor as set forth in claim 11,
wherein a flux barrier for preventing the leakage of magnetic flux of the magnets is formed in the core or in connection portions between the core and the teeth.

14. The flux concentration-type motor as set forth in claim 13,
wherein the flux barrier includes pin holes formed through the connection portions between the core and the teeth.

15. The flux concentration-type motor as set forth in claim 13,
wherein the flux barrier includes barrier holes formed through ends of the teeth adjacent to the core.

16. The flux concentration-type motor as set forth in claim 13,
wherein the flux barrier includes bridge holes formed through portions for connecting the neighboring teeth.

17. The flux concentration-type motor as set forth in claim 11,
wherein the core of the rotor is produced by spiral winding.

18. The flux concentration-type motor as set forth in claim 17,
wherein guide holes for stacking plural sheets using iron rods are formed through the core of the rotor.

19. A flux concentration-type motor comprising:
a ring-shaped stator, in which coils are wound on a plurality of teeth radially arranged; and
a rotor, located at the center of the stator, having a plurality of magnets, each of which is disposed between radially-arranged teeth, such that poles, having the same polarity, of the magnets face each other, and rotated by the interaction with the stator.

20. The flux concentration-type motor as set forth in claim 19, wherein the rotor includes:
a ring-shaped rotor core;
a plurality of the teeth protruded from the core toward the stator and radially arranged; and
a plurality of the magnets arranged between the teeth.
